(19) United States
(12) Patent Application Publication
(10) Pub. No.: US 2004/0210684 A1
(43) Pub. Date: Oct. 21, 2004

(54) Method and device for adapting the data rate of a date stream

(76) Inventors: Wolfgang Granig, Sachsenburg (AT); Christian Mandl, Villach (AT)

Correspondence Address: EDWARDS & ANGELL, LLP, P.O. BOX 55874, BOSTON, MA, 02205, US

(21) Appl. No.: 10/476,356

(22) PCT Filed: Apr. 16, 2002
(86) PCT No.: PCT/EP02/04216

(30) Foreign Application Priority Data
Apr. 30, 2001 (DE) 101 21 198.8

(51) Int. Cl. G06F 3/00

(52) U.S. Cl. 710/15

(57) ABSTRACT

An improved method and a corresponding device for adapting the data rate of a data stream by using a FIFO memory (1) into which data packets of the data stream are written at a first data rate and from which the data packets are output at a second data rate, is proposed. According to the invention a certain pause (T_{P}) is inserted after each output data packet until the next data packet is output. In the event of a no-load of the FIFO memory (1) an additional pause (T_{FE}) is produced, which is detected. In addition, the number of the data packets output between a preceding no-load and the current no-load of the FIFO memory (1) is ascertained. The longest pause between the data packets can be ascertained with the aid of this information, wherein, as a function of a comparison of this longest pause with the product of the output data packets between two successive FIFO no-loads and the pause (T_{P}) to be inserted between the output data packets, it is ascertained whether an increase in the inserted pause (T_{P}) is possible.

The present invention relates to a method for adapting the data rate of a data stream, in particular of a data packet-oriented data stream, and to a corresponding device, data packets being written into a FIFO memory (“first in first out”) at a first data rate and being read out from the FIFO memory at a second data rate.

In many DMT data transmissions (“discrete multi tone”), such as the modern COFDM modulation method (“coded orthogonal frequency division multiplex”), the data to be transmitted, i.e. the individual bits or bytes, are coded as follows. The data, for example MPEG data packets (“moving picture experts group”) are provided with a block code as an external code and a convolutional code as an inner code for channel coding, in order to make data transition more secure. In this connection, redundant bits, which increase transmission security, are added to the bits of data or message to be transmitted. The data provided with a redundancy of this type are modulated to a large number of different carriers with the aid of an inverse fast Fourier transformation (IFFT), wherein the individual carriers can additionally be modulated by QPSK (“quadrature phase shift keying”), 16QAM (“quadrature amplitude modulation”) or 64QAM. A distinction is made in this connection, for example between a 2k mode (1512 carrier) and an 8k mode (6048 carrier), as a function of the number of carriers used. The OFDM signal resulting therefrom is therefore composed of a large number of modulated carriers.

Each OFDM symbol thus obtained is sent at a specific time, this time being called “useful time” and depending on the respectively used transmission bandwidth. Therefore, transmission bandwidths of, for example 8 MHz, 7 MHz and 6 MHz are known, the longest OFDM symbol to be expected at a bandwidth of 6 MHz. However, with multipath propagation it is also possible for echoes to impair the actual OFDM signal. To keep this as low as possible a protection period called a “guard period” has been introduced, in which no symbol is transmitted and consequently the signal has time to transiently oscillate and to allow echoes to die away. The guard period is, for example, 1/32, 1/16, ⅛ or ¼ of the “useful time”, wherein the “guard period” and “useful time” together result in the “symbol time” of the respective symbol.

FIG. 3 shows an example of the course over time of the data output during block processing, for example according to a COFDM modulation method, of MPEG data packets, wherein the respectively inserted “guard period” can also be seen in FIG. 3. The number of MPEG data packets per OFDM symbol depends, as will be described in more detail hereinafter, on the type of modulation of the individual carriers, on the number of carriers used and on the code rate used.

When receiving data or OFDM symbols which have been coded or modulated according to the above-described method, data processing takes place in exactly the reverse sequence, so the desired data (for example MPEG data packets) are available after carrying out a convolutional decoding and a block decoding.

A problem connected with the above-described COFDM modulation method is that this method is a block-oriented transmission method, MPEG decoders generally requiring a continuous data stream to ensure functioning thereof, in particular the FIFO functionality thereof. For this reason suitable data rate adaptation is required.

The data rate at the output of a COFDM receiver may be calculated by the following formula:

$${X}_{out} = \frac{CARRIER \cdot \frac{1}{CRATE} \cdot \frac{bits}{CARRIER}}{( 1 + GUARD ) \cdot USEFUL\_TIME} = \frac{\frac{bits}{CRATE}}{( 1 + GUARD ) \cdot USEFUL\_TIME}$$

In this connection the parameter CARRIER designates the number of carriers used, for example 1512 or 6048, while CRATE designates the code rate used in convolutional coding, for example ½, ⅔, ¾, ⅚ or ⅞. With QPSK modulation, the term bits/CARRIER has the value 2 with 16QAM modulation the value 4 and with 64QAM modulation the value 6. The parameter GUARD designates the relationship between the “guard period” and the “useful time”, so the parameter GUARD can, for example, have the value ¼, ⅛, 1/16 or 1/32. The parameter USEFUL_TIME designates the duration of the above-described “useful time” in which an OFDM symbol is transmitted, the “useful time” being 896 μs at a transmission bandwidth of 8 MHz, 1024 μs at a transmission bandwidth of 7 MHz or 1194.7 μs at a transmission bandwidth of 6 MHz.

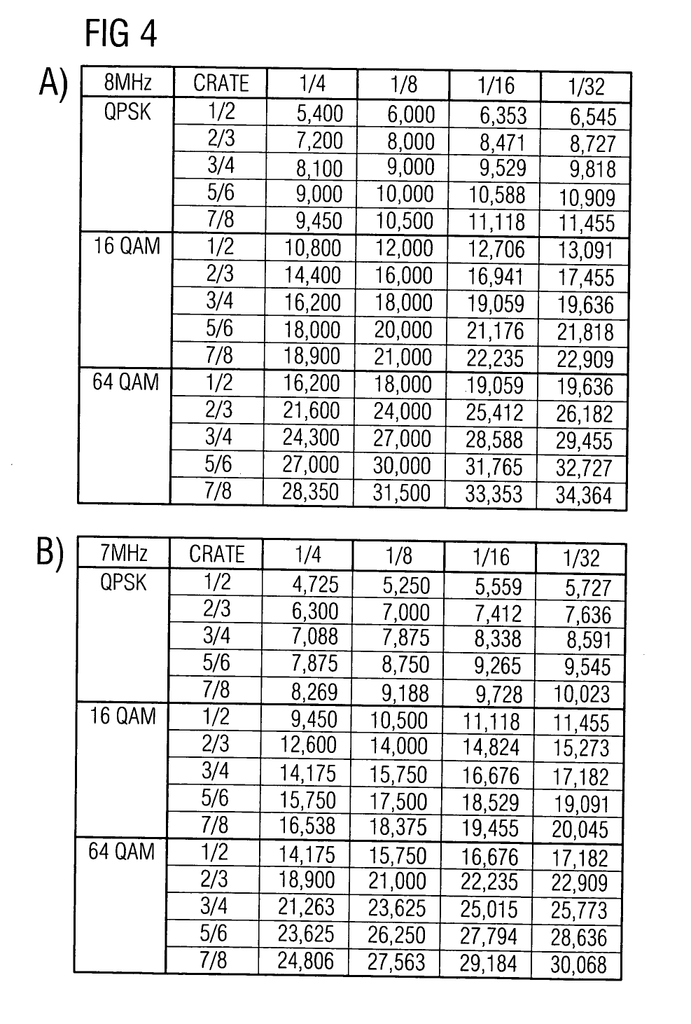

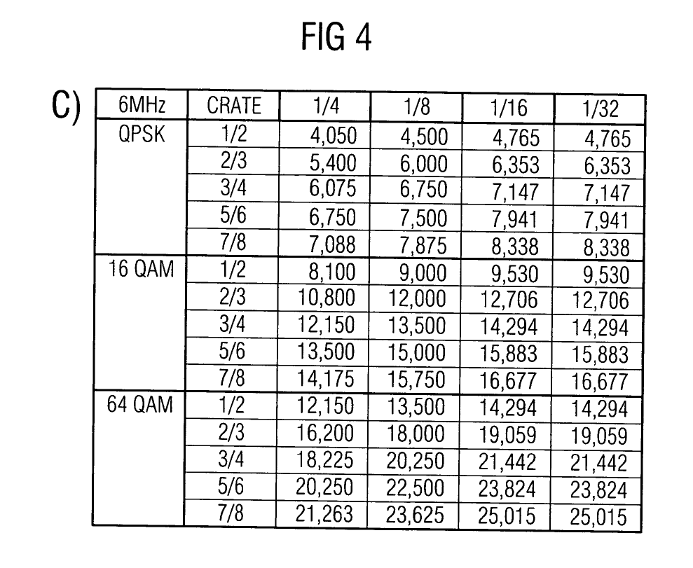

FIG. 4A shows the data rate XOUT at the output of a COFDM receiver for various values of CRATE, GUARD and for various modulation methods at a transmission bandwidth of 8 MHz. FIGS. 4B and 4C show corresponding values for the output data rates for a transmission bandwidth of 7 MHz and 6 MHz respectively. The output data rate is shown in Mbits/s in each case.

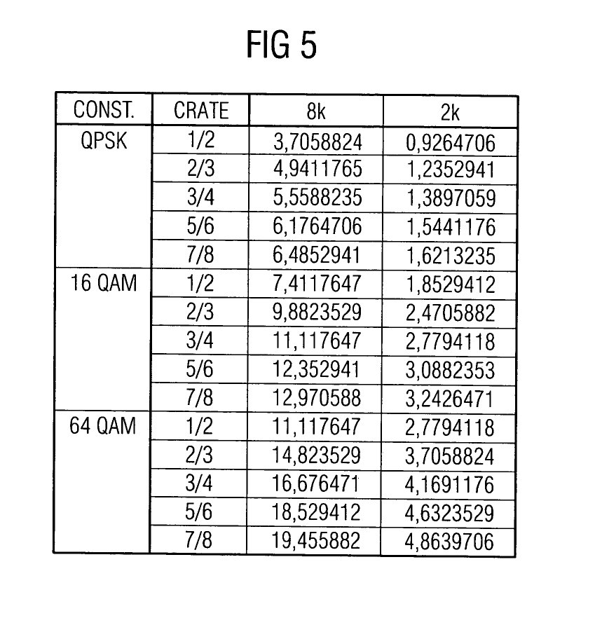

From the above formula it can be seen that the output data rate is independent of the number of carriers used, i.e. independent of the mode used (for example 2k mode or 8k mode). However, as before the number of MPEG data packets per OFDM symbol is different, and this can be seen from the diagram of FIG. 5.

FIG. 5 shows, for a constant transmission bandwidth, the number of MPEG data packets per OFDM symbol for the various types of modulation and for various CRATE values of the convolutional code rate, a distinction being made between the 8k mode and the 2k mode. It can be seen from FIG. 5 that the number of MPEG data packets per OFDM symbol differs as a function of the respectively used mode (2k mode or 8k mode).

The use of a FIFO memory to adapt the data rate of a data stream is known, wherein the data or data packets can be written into the FIFO memory at a specific data rate and can be read out at a different data rate. The FIFO memory can, for example, be designed in the form of a dual port RAM memory.

FIG. 6A shows an example of a dual port RAM FIFO memory 1 which has a data input terminal for writing in data or data packets D_{IN} and a data output terminal for reading out data or data packets D_{OUT}. A clock signal CLK_{IN} for writing-in the data is applied to a further terminal, while a variable and configurable clock signal CLK_{OUT} is used to read-out the data, so the data rate can be adapted as desired by corresponding adjustment of this read-out clock signal CLK_{OUT}.

A problem when using the arrangement shown in FIG. 6A is, however, that only by sufficiently large dimensioning of the FIFO memory 1 can it be ensured that the FIFO queue does not overflow. In addition, a plurality of different clock signals have to be made available at one and the same chip module, and this is complicated during chip synthesis and testing of the chip. In addition, dual port RAM FIFO memories require a relatively high chip area.

FIG. 6B shows a further known possibility of data rate adaptation. Here, a FIFO memory 1 in combination with a preceding module 4 and a following module 5 is shown in FIG. 6B. The FIFO memory 1 is, in principle, merely a buffer FIFO memory, the input data D_{IN} additionally being distributed in the preceding module 4 and in the following module 5. As a result, the data is processed such that the data is distributed according to the corresponding needs in each case, at the output of the corresponding block-processing circuits. The advantage of the arrangement shown in FIG. 6B is that the FIFO memory 1 does not have to operate so exactly as in the arrangement shown in FIG. 6A, as an additional uniform distribution is possible owing to the following module 5 and the following functional block 5. However, the disadvantage of the arrangement shown in FIG. 6B is that the design of the FIFO memory 1 is substantially more complicated as the data rates within the arrangement or within the system are often not exactly known and depend on the implementation of the preceding module 4 or of the preceding functional block 4.

The object of the present invention is to provide a method and a corresponding device for adapting the data rate of a data stream, so adaptation of the data rate which is as exact as possible can be achieved as simply as possible.

This object is achieved according to the invention by a method with the features of claim 1 and a device with the features of claim 8. The sub-claims each define preferred and advantageous embodiments of the present invention.

The present invention proceeds from the fact that data packets of a data stream are written into and read-out from a FIFO memory. Writing of the data packets into the FIFO memory and reading the data packets out of the FIFO memory can take place in this connection at different data rates.

To achieve the desired data rate at the output of the FIFO memory the following control loop is implemented which facilitates adaptive data rate adaptation.

A preadjusted or fixed pause or time interval is inserted between each output or read-out data packet, i.e. a specific time elapses after each output data packet before the next data packet is output. In addition, it is monitored as to when the FIFO memory is operating at no-load. Ultimately, a new valid pause value is determined and adjusted for the data packets to be successively read out, as a function of the sum of the individual pauses which have been inserted between the data packets output or read-out between two successive no-loads of the FIFO memory.

In the event of a no-load of the FIFO memory, an additional pause is produced which is preferably likewise measured. If the FIFO memory is running at no-load, the longest or maximum pause between two successive data packets can be ascertained, which corresponds to the sum of the pause inserted between the output data packets and the additional pause caused by the no-load. The sum of the individual pauses, which have been inserted between the data packets output between two successive no-loads of the FIFO memory is accordingly compared with this maximum or longest pause in order to determine as a function thereof a new value for the pause to be inserted between data packets to be successively output. In this connection, the new value for the pause to be inserted between two successive data packets is to be dimensioned such that the sum of the individual pauses, which are inserted between the data packets read-out between two successive no-loads of the FIFO memory, is smaller than the longest or maximum pause between two data packets (in the event of FIFO no-load), wherein it is sensible for a certain reserve to be taken into account in this regard to ensure that the FIFO memory always reliably runs at no-load (and cannot overflow). In addition, by taking into account a certain reserve it can be ensured that the pause does not fall below a certain maximum, wherein the start of a corresponding symbol, for example of an OFDM symbol, can also be ascertained via the pause.

If the inserted pause is greater than the duration of a data packet, the data output clock frequency can be reduced, in particular reduced by the factor 2, wherein in this case the above-described control loop has to start from the beginning again in order to control the data rate at the output of the FIFO memory anew.

Although the present invention can preferably be used to adapt the data rate at the output of a COFDM receiver when processing MPEG data packets, the present invention is of course not restricted to this preferred area of application, but can be used wherever adaptation of the data rate to a data stream incorporating a sequence of data packets is desired. In this regard, the present invention can, for example, also be used in ATM data transfer methods (“asynchronous transfer mode”) or Ethernet data transfer methods, etc.

The present invention will be described in more detail hereinafter with reference to the accompanying drawings and with the aid of a preferred embodiment.

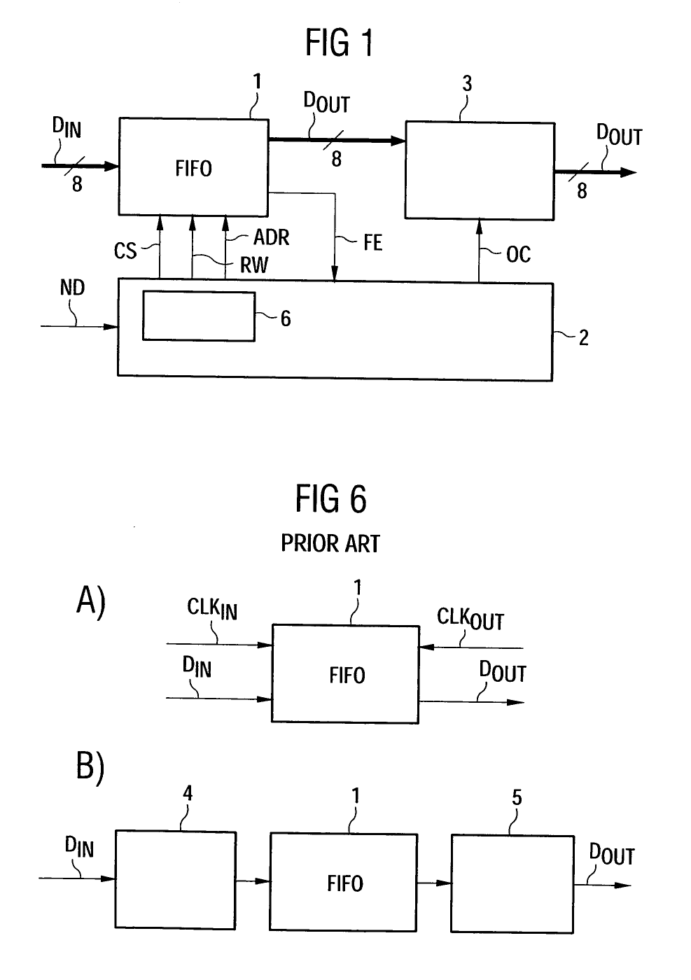

FIG. 1 shows a simplified block diagram of a device according to the invention, based on a FIFO memory for adapting the data rate of a data stream,

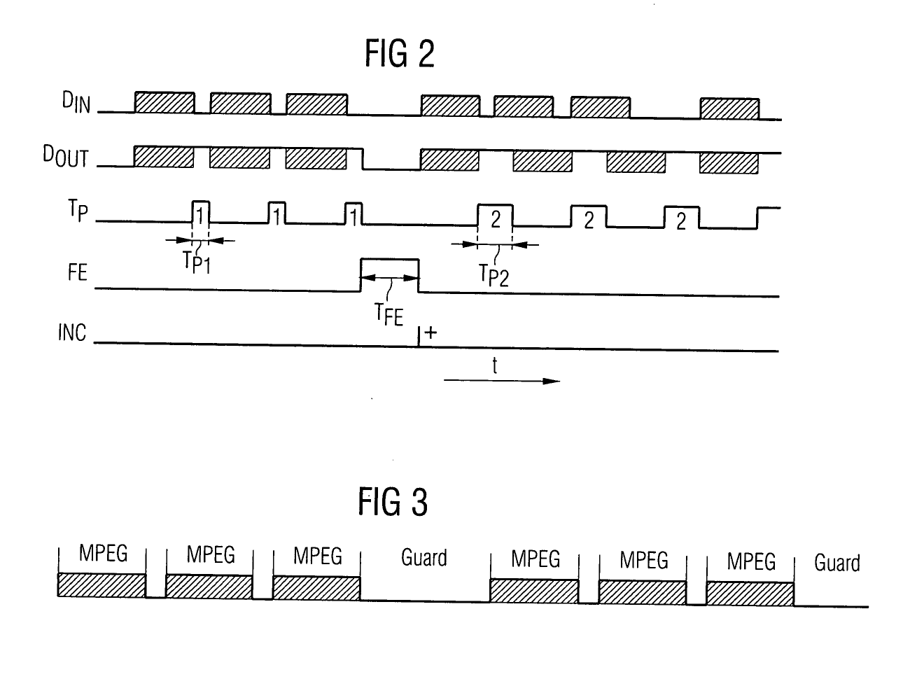

FIG. 2 shows the course over time of various signals in the embodiment shown in FIG. 1 to clarify the mode of operation according to the invention,

FIG. 3 shows the course over time of the outputting of MPEG data packets during block processing,

FIG. 4A to FIG. 4C show examples of the output data rate of a COFDM receiver for various transmission bandwidths,

FIG. 5 shows an example of the number of MPEG data packets per OFDM symbol at the output of a COFDM receiver in 8k mode and 2k mode, and

FIG. 6A and FIG. 6B show diagrams of known solutions to achieve a data rate adaptation by using a FIFO memory.

FIG. 1 shows a FIFO memory 1 into which the data D_{IN} of a data stream is written and from which it is read out in the form of output data D_{OUT}. In the illustrated embodiment it is assumed that eight respective bits are written-in and read-out simultaneously. The input data D_{IN} can, in particular, be MPEG data packets of a COFTM receiver, of which the data rate is to be adapted for subsequent processing in an MPEG decoder (not shown). Ideally, the aim here is for the input data stream of an MPEG decoder of this type to comprise MPEG data packets as uniformly distributed as possible with small gaps or pauses.

The FIFO memory 1 shown in FIG. 1 is controlled by a FIFO controller 2, which is a component of a control loop for adaptive data rate adaptation and adjusts the data rate occurring at the output of the FIFO memory 1 according to the method described in more detail hereinafter.

A control signal RW (“read/write”) is applied by the FIFO controller 2 to the FIFO memory 1 and together with an addressing signal ADR, controls writing of a data packet into the FIFO memory 1 and reading-out of a data packet from the FIFO memory 1. The FIFO controller 2 is supplied with a control signal ND (“new data”) which informs the FIFO controller 2 when there is new data for writing into the FIFO memory 1. Furthermore, the FIFO controller 2 generates a further control signal CS (“chip select”) for the FIFO memory 1 which, to save energy, only allows access to the memory when there is new data for writing into the FIFO memory 1 or there is data for reading-out at the output of the FIFO memory 1. The FIFO controller 2 monitors via a further control signal FE (“FIFI empty”) whether a no-load of the FIFO memory 1 has occurred or not. The mode of operation of the FIFO controller 2 is as follows.

A data packet is written into the FIFO memory 1 and output again. In the process, a certain time T_{P} elapses after each output data packet until the next data packet is output. For this purpose, the FIFO controller 2 comprises a counter 6 monitoring this time interval or pause T_{P} by counting corresponding clock pulses.

In the event of a no-load of the FIFO memory 1, an additional pause TFE is produced which can be accordingly measured or detected by the FIFO controller 2, for example with the aid of a zero counter. Furthermore, the FIFO controller 2 comprises a further counter 6 which counts the number of data packets since the preceding no-load of the FIFO memory up to the current no-load of the FIFO memory 1.

With the aid of this information the FIFO controller 2 can determine the sum of the pauses T_{P}, which have been inserted between the data packets output between two successive no-loads of the FIFO memory 1, as follows:

T_{Σ}=N·T_{Pi}

Here, N designates the number of data packets which have been output between the preceding no-load of the FIFO memory 1 and the current no-load and T_{Pi} denotes the current valid pause value for the pause on outputting data packets from the FIFO memory 1.

Furthermore, the FIFO controller 2 ascertains the greatest or longest pause T_{Pmax} occurring in the event of FIFO no-load, between the data packets, wherein:

T_{Pmax}=T_{Pi}+T_{FE}

By comparing the total pause value T_{Σ}with the value of the greatest pause T_{Pmax}, the FIFO controller 2 can ascertain whether, for example, an increase in the pause between two successive data packets from, for example, T_{P1} to T_{P2} (cf. FIG. 2) is possible. It should be taken into account in this connection when adjusting the pause between two successive data packets that the following relationship is to be adhered to:

N·T_{Pi}<T_{Pmax}

In other words, in the event of a pause increase, the product from the sum of the currently inserted pause and the selected pause increase, on the one hand, and the number of data packets between two successive FIFO no-loads on the other hand, must be smaller than the greatest pause occurring between the data packets in the event of a pause increase on a FIFO no-load. In the example shown in FIG. 2 this means that the following must apply:

N·T_{P2}<T_{Pmax} where T_{P2}=T_{P1}+ΔT_{P}

Here, ΔT_{P} designates the selected pause increase, proceeding from the current inserted pause T_{P1}.

FIG. 2 shows how, in the event of a FIFO no-load, the value of the current inserted pause T_{P1} is incremented, after the additional pause T_{FE} caused by the FIFO no-load has expired, in order to obtain a new value T_{P2} for the pause inserted between the data packets (cf. the signal course INC shown in FIG. 2).

When choosing a new pause value it is sensible to take into account a certain reserve to ensure that the FIFO memory 1 always reliably runs at no-load, cannot overflow and, in addition, the pause value does not fall below a certain maximum pause T_{Pmax}. For the example shown in FIG. 2 the following must accordingly apply:

N·T_{P2}+R_{Res}<T_{Pmax}

Here, T_{Res} designates the reserve to be taken into account when increasing the pause value.

If the pause inserted between two successive data packets during data packet output is greater, owing to a pause increase, than the duration of an output data packet, the FIFO controller 2 can reduce, in particular halve (or reduce by the factor 2) the data output clock frequency. In this case, the FIFO controller 2 must, however, start the above-described control loop from the beginning with the adaptive data rate adaptation, which, in principle, corresponds to an adaptive adaptation of the pause T_{P} between two successive data packets, to be able to ensure optimum data rate adaptation.

In the embodiment shown in FIG. 1 the data D_{OUT} read-out from the FIFO memory 1 is supplied to an output interface 3, controlled by the FIFO controller 2 via a control signal OC (“out control”). This output interface 3 can carry out a conversion into a predetermined data format or—if this should be necessary—also a parallel/serial conversion of the output data D_{OUT}. Here, it can be communicated to the output interface 3 via the control signal OC when the data is to actually be output.

As can be seen from the diagram of FIG. 2, for the case where the input data D_{IN} is present, for example in the form of MPEG data packets, filtering of frames which comprise a plurality of MPEG data packets can be achieved with the aid of the present invention. The “guard period” or protection time described at the outset can thus be eliminated or smoothed out.

In general, the present invention is therefore basically preferably used where specific frames are to be filtered out in order to subsequently process the data resulting therefrom, for example at a lower data rate, so a “buffer-filter-data rate adaptation” can be achieved.

1. Method for adapting the data rate of a data stream, data packets of the data stream being written into a FIFO memory (1) at a first data rate and being output from the FIFO memory (1) at a second data rate, characterised in that the data packets are output with a fixed time pause (T_{P}) between the data packets, in that an additional pause (T_{FE}) occurring in the event of no-load of the FIFO memory (1) is detected and a maximum pause between the data packets ascertained therefrom, and in that, as a function of a comparison of the sum of the individual pauses (T_{P}), which are inserted between the data packets output between two successive no-loads of the FIFO memory (1), and the maximum pause, the value for the pause (T_{P}), which is to be inserted between data packets to be successively output, is adjusted.

2. Method according to claim 1, characterised in that the maximum pause is ascertained by calculating the sum of the pause (T_{P}) inserted between the data packets and the additional pause (T_{FE}) occurring as a consequence of a no-load of the FIFO memory (1).

3. Method according to claim 1, characterised in that the value of the pause (T_{P}) inserted between the data packets output from the FIFO memory (1) is detected, in that the number of data packets output between the two successive no-loads of the FIFO memory (1) is detected, and in that the sum of the individual pauses (T_{P}), which is inserted between the data packets output between the two successive no-loads of the FIFO memory (1), is ascertained by multiplying the detected number of data packets by the detected value of the pause (T_{P}).

4. Method according to claim 3, characterised in that the value of the pause (T_{P}), the value of the additional pause (T_{FE}) occurring in the event of a no-load of the FIFO memory (1) and the number of the data packets output between two successive no-loads of the FIFO memory (1) is detected with the aid of a counter (6).

5. Method according to claim 1, characterised in that a new value for the pause (T_{P}) inserted between the data packets output from the FIFO memory (1) is adjusted such that the sum of the individual pauses (T_{P}) resulting therefrom, which are inserted between the data packets output between two successive no-loads of FIFO memory (1) is smaller than the value of the maximum pause in the event of a no-load of the FIFO memory (1).

6. Method according to claim 5, characterised in that a new value for the pause inserted between the data packets output from the FIFO memory (1) is adjusted such that the sum of the individual pauses (T_{P}), which are inserted between the data packets output between two successive no-loads of the FIFO memory (1), added to a certain reserve value, is smaller than the value of the maximum pause between the data packets.

7. Method according to claim 1, characterised in that the clock frequency with which the data of the data packet is output from the FIFO memory (1) is halved if the pause (T_{P}) inserted between the output data packets is greater than the duration of a data packet.

8. Device for adapting the data rate of a date stream, comprising a FIFO memory (1) into which data packets are written at a first data rate and from which the data packets are output at a second data rate, and comprising a memory controller (2) for controlling writing of the data packets into the FIFO memory (1) and outputting of the data packets from the FIFO memory (1), characterised in that the memory controller (2) is designed to control the FIFO memory (1) such that the data packets are output from the FIFO memory (1) with a certain fixed pause (T_{P}) between the data packets, in that the memory controller (2) is designed to detect a no-load of the FIFO memory (1), in that the memory controller (2) is designed to detect an additional pause occurring in the event of a no-load of the FIFO memory (1) in order to determine the value of a maximum pause between two successive data packets, and in that the memory controller (2) is designed in such a way that, as a result of a comparison of the sum of the individual pauses (T_{P}), which are inserted between the data packets output between two successive no-loads of the FIFO memory (1), with the value of the maximum pause adjusts a new value for the pause (T_{P}) which is to be inserted between data packets of the FIFO memory (1) to be successively output.

9. Device according to claim 8, characterised in that the memory controller (2) is designed to carry out the method according to claim 1.

10. Device according to claim 8, characterised in that the memory controller (2) comprises at least one counter (6) for detecting the current value of the pause (T_{P}) inserted between the data packets output from the FIFO memory (1), the additional pause occurring in the event of a no-load of the FIFO memory (1) and a number of the data packets output from the FIFO memory (1) between the two successive no-loads of the FIFO memory (1), the memory controller (2) ascertaining the sum of the individual pauses (T_{P}), which are inserted between the data packets output between the two successive no-loads of the FIFO memory (1), by multiplying the detected number of data packets output between the two successive no-loads by the detected current value of the inserted pause (T_{P}).

11. Device according to claim 8, characterised in that the memory controller (2) is designed such that it adjusts a new value for the pause (T_{P}) inserted between the data packets output from the FIFO memory (1) such that the sum resulting therefrom of the individual pauses (T_{P}), which are inserted between the data packets output between two successive no-loads of the FIFO memory (1), is smaller than the value of the maximum pause.

12. Device according to claim 11, characterised in that the memory controller (2) is designed such that it adjusts a new value for the pause (T_{P}) inserted between the data packets output from the FIFO memory (1) such that the sum resulting therefrom of the individual pauses (T_{P}p), which are inserted between the data packets output between two successive no-loads of the FIFO memory (1), added to a specific reserve value, is less than the value of the maximum pause.

13. Device according to claim 8, characterised in that the memory controller (2) is designed to halve a data output clock frequency of the FIFO memory (1) if the value of the pause (T_{P}) inserted between the data packets output from the FIFO memory (1) is greater than the duration of a data packet.
